(19) United States
(12) Patent Application Publication
(10) Pub. No.: US 2025/0115485 A1
(43) Pub. Date: Apr. 10, 2025

(54) METHODS FOR MAKING ZEOLITE-Y PARTICLES

(71) Applicant: Saudi Arabian Oil Company, Dhahran (SA)

(72) Inventors: Lianhui Ding, Dhahran (SA); Faisal Alotaibi, Al-Khobar (SA); Mohammad F. Aljishi, Dhahran (SA)

(73) Assignee: Saudi Arabian Oil Company, Dhahran (SA)

(21) Appl. No.: 18/480,949

(22) Filed: Oct. 4, 2023

(51) Int. Cl. C01B 39/24; B01J 29/08; B01J 35/02; B01J 35/10; B01J 37/08

(52) U.S. Cl. CPC C01B 39/24; B01J 29/084; B01J 35/40; B01J 35/617; B01J 35/633; B01J 35/635; B01J 35/647; B01J 37/08; C01P 2004/02; C01P 2004/62; C01P 2006/12; C01P 2006/14; C01P 2006/16

(57) ABSTRACT

A method for making zeolite-Y particles may include forming an initial zeolite precursor solution including an alumina source material and a silica source material in a solvent, and subjecting the initial zeolite precursor solution to a first heating process to form zeolite-Y particles in a residual liquid solution, and separating the zeolite-Y particles from the residual liquid solution. The residual liquid solution may include some remaining non-crystalized silica source material, and the residual liquid solution may have a different alumina to silica molar ratio than the initial zeolite precursor. The method may further include forming a recycled zeolite precursor solution that may include at least a portion of the residual liquid solution and one or both of additional alumina source material or additional silica source material, such that the recycled zeolite precursor solution has an alumina to silica molar ratio within 10% of the alumina to silica ratio of the initial zeolite precursor solution. The method may further include subjecting the recycled zeolite precursor solution to a second heating process to form additional zeolite-Y particles.

### FIELD

The embodiments described herein generally relate to porous materials and, more particularly, to zeolites.

### BACKGROUND

Materials that include pores, such as zeolites, may be utilized in many petrochemical industrial applications. For instance, such materials may be utilized as catalysts in a number of reactions that convert hydrocarbons or other reactants from feed chemicals to product chemicals. Zeolites may be characterized by a microporous structure framework type. Various types of zeolites have been identified over the past several decades, where zeolite types are generally described by framework types, and where specific zeolitic materials may be more specifically identified by various names such as zeolite-Y, ZSM-5 or beta.

Zeolite containing catalysts and adsorbents have widespread uses in many diverse industries. Exemplary industries include the petrochemical industry in refinery, gas separation, and carbon dioxide separation and capture processes. In the petroleum industry, for example, zeolite containing catalysts may be included in processes such as fluid catalytic cracking (FCC) and hydrocracking to catalyze reactions such as hydrogenation, dehydrogenation, isomerization, alkylation, and cracking, for example. Zeolite containing adsorbents may be utilized in the separation of paraffins or aromatic isomers, and in drying processes to remove water and other impurities from hydrocarbon streams.

### SUMMARY

Embodiments of the present disclosure are directed to methods for making zeolite-Y particles. Conventional methods for making zeolite-Y particles may suffer from relatively low yield of zeolite-Y particles. Such conventional methods may utilize a process where a zeolite precursor solution, containing silica precursor materials and alumina precursor material, is heated to form zeolite-Y particles in a residual liquid solution that still contains some amount of one or both of silica precursor materials and alumina precursor material. Conventionally, this residual liquid solution is discarded as waste. However, the methods described herein may utilize the residual liquid solution to produce a new batch of zeolite precursor solution from which additional zeolite-Y particles may be produced. For example, additional silica precursor materials and/or additional alumina precursor material may be added to the residual liquid solution to make a recycled zeolite precursor solution that has amounts of silica precursor materials and/or alumina precursor material suitable for forming additional zeolite-Y particles. In such embodiments, zeolite-Y particle yields may be substantially increased as compared with conventional methods.

According to one or more embodiments, a method for making zeolite-Y particles may comprise forming an initial zeolite precursor solution comprising an alumina source material and a silica source material in a solvent, and subjecting the initial zeolite precursor solution to a first heating process to form zeolite-Y particles in a residual liquid solution, and separating the zeolite-Y particles from the residual liquid solution. The residual liquid solution may comprise some remaining non-crystalized silica source material, and the residual liquid solution may have a different alumina to silica molar ratio than the initial zeolite precursor. The method may further comprise forming a recycled zeolite precursor solution that may comprise at least a portion of the residual liquid solution and one or both of additional alumina source material or additional silica source material, such that the recycled zeolite precursor solution has an alumina to silica molar ratio within 10% of the alumina to silica ratio of the initial zeolite precursor solution. The method may further comprise subjecting the recycled zeolite precursor solution to a second heating process to form additional zeolite-Y particles.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1A depicts a micrograph of Y zeolite particles, according to one or more embodiments described herein;

FIG. 1B depicts another micrograph of Y zeolite particles, according to one or more embodiments described herein;

Reference will now be made in greater detail to various embodiments, some embodiments of which are illustrated in the accompanying drawings.

### DETAILED DESCRIPTION

One or more embodiments presently described herein are directed to methods of making zeolite-Y particles. In some embodiments, the zeolite-Y particles are nano-sized, as described herein. In general, a portion of material utilized in the making of the zeolite-Y particles is recycled and reused for the making of additional zeolite-Y particles, increasing product yield while resulting in comparable or identical zeolite-Y particles. Furthermore, one or more methods described herein may not include a structure directing agent and may utilize a single pot synthesis, further increasing efficiency and cost.

As used throughout this disclosure, “zeolites” or “zeolite materials” generally refer to micropore-containing inorganic materials with regular intra-crystalline cavities and channels of molecular dimension, as would be understood by those skilled in the art. Zeolites generally comprise a crystalline structure, as opposed to an amorphous structure. The microporous structure of zeolites may render large surface areas and desirable size-/shape-selectivity, which may be advantageous for catalysis. Accordingly, zeolites may be utilized in many petrochemical industrial applications, such as, for instance, reactions that convert hydrocarbons or other reactants from feed chemicals to product chemicals by cracking.

Generally, zeolites may be characterized by a microporous framework type, which defines their microporous structure. Framework types are described in, for instance, “Atlas of Zeolite Framework Types” by Christian Baerlocher et al., Sixth Revised Edition, published by Elsevier, 2007, the teachings of which are incorporated by reference herein.

As described herein, the zeolites formed are zeolite-Y. Zeolite-Y generally comprises an FAU framework type. Zeolite-Y described herein may be characterized, in some embodiments, as ultra-stable zeolite-Y (USY). As used herein, “zeolite-Y” and “USY” refer to a zeolite having a FAU framework type according to the IZA zeolite nomenclature and consisting majorly of silica and alumina, as would be understood by one skilled in the art.

According to the methods for making zeolite-Y particles described herein, in general, a first hydrogel may be formed, the first hydrogel may be subjected to a heating process to form solid zeolite-Y particles in a residual liquid solution. The solid zeolite-Y particles may be separated from the residual liquid solution. A recycled hydrogel may be formed the comprises all or a portion of the residual liquid solution, and the recycled hydrogel can be utilized to form additional zeolite-Y particles. These steps are discussed in detail hereinbelow.

As described hereinabove, in one or more embodiments, in an initial step, an initial zeolite precursor solution is formed. Generally, zeolite precursor solutions may refer to those that include the materials that will form the zeolite, such as silicon, aluminum, and oxygen atoms. Zeolite precursor solutions may include a solvent and at least an alumina source material and a silica source material. The initial zeolite precursor solution may further comprise a basic compound, as described herein. The solvent may be water, but other solvents are not necessarily excluded from the scope of the presently disclosed methods.

Without limitation, the alumina source materials may comprise one or more of alumina, NaAlO₂, Al₂(SO₄)₃, Al(NO₃)₃, AlCl₃, NaAlO₂, or Al₂O₃. Also, without limitation, the silica source material may comprise one or both of colloidal silica, fumed silica, or tetraethyl orthosilicate (TEOS), or Na₂SiO₃. It should be understood that molecules of source materials may disassociate in solution, and that the initial zeolite precursor solution comprising an alumina source material or a silica source material may refer to the initial zeolite precursor solution comprising the initial molecules of the source materials or disassociated components of these molecules. The basic compound may be chosen from NaOH, KOH, Mg(OH)₂, and the basic compound composition is not necessarily limited.

According to one or more embodiments, the initial zeolite precursor solution may generally be prepared by mixing the alumina source material and the silica source material into a solvent. For example, the alumina source material may be mixed into a solvent, the silica source material may be mixed into another solvents, and these two mixtures may be combined. The ordering of combination of the mixing of the alumina source material and the silica source material into the solvent is not necessarily limited. Similarly, a basic compound may be mixed into the solution that includes the alumina source material and silica source material, or may be added already mixed with the solvent.

According to one or more embodiments, the mixture that includes the alumina source material and silica source material may be aged to form the initial zeolite precursor solution. Aging may be for a period of time of at least 10 hours, such as from 10 hours to 48 hours, from 10 hours to 30 hours, or from 15 hours to 25 hours. The aging may include agitating the mixture, such as stirring the mixture. In some embodiments, the aging may be at an elevated temperature, such as about 30° C., but in other embodiments the aging may be at ambient temperature such as about 25° C. Without being bound by theory, while it is not believed that the overall chemical composition substantially changes in the mixture during aging, it is believed that aging may form zeolite nuclei from which zeolitic particles may be formed in downstream steps by crystallization. In general, final crystal sizes may be smaller when more nuclei are formed during aging, and relatively small crystal size and particle size may be desired.

In one or more embodiments, the molar ratio of components in the initial zeolite precursor solution (and that in the recycled zeolite precursor solution, as described herein), may be 8-12 Na₂O: 1 Al₂O₃: 8-16 SiO₂: 200-400 H₂O. Molar ratios of any two of these components are contemplated herein based on the described molar ratio of Na₂O, alumina, silica, and water.

In one or more embodiments, the method of making a zeolite-Y material may exclude the use of an organic structure-directing agent, which in conventional embodiments, may be incorporated into the initial zeolite precursor solution. For example, the method may not utilize one or more of tetraethylammonium cation, N,N-dimethyl-2,6-cis-dimethylpiperdinium cation, dimethyldiisopropylammonium cation, N,N,N-trimethylcyclohexanaminium cation, N-ethyl-N,N-dimethylcyclohexanaminium cation, N-isopropyl-N-methyl-pyrrolidinium cation, N-isopentyl-N-methyl-pyrrolidinium cation, and N-isobutyl-N-methyl-pyrrolidinium cation. Without being bound by theory, it is believed that the methods of making a zeolite-Y material of the present disclosure that do not utilize an organic structure-directing agent may be less costly than comparable methods of making a zeolite-Y material that do utilize an organic structure-directing agent.

Following the forming of the initial zeolite precursor solution, the initial zeolite precursor solution may be subjected to a heating process (sometimes referred to herein as a crystallization process), which may crystalize a portion of the materials in the initial zeolite precursor solution to form the zeolite-Y particles. The heating process may be under increased pressure and/or at relatively high levels of humidity as compared to ambient environmental conditions, such as those present in an autoclave. For example, a portion of or the entirety of the heating process may be performed in an autoclave at autoclave conditions. As would be understood in to those in the art, autoclave conditions may generally include increased pressure and/or the presence of steam. In other embodiments, the heating steps may be under relatively dry conditions in an oven with near atmospheric humidity.

According to one or more embodiments, the heating process may comprise two heat treatments, a first heat treatment at a temperature of from 50° C. to 70° C., and a second heat treatment (following the first heat treatment) at a temperature of from 80° C. to 120° C. The first heat treatment may be for a time period of from 4 hours to 24 hours, and the second heat treatment may be for a time period of from 4 hours to 24 hours. For example, the first heat treatment may be at a temperature of from 50° C. to 55° C., from 55° C. to 60° C., from 60° C. to 65° C., from 65° C. to 70° C., or any combination of one or more of these ranges, for a time period of from 4 hours to 8 hours, from 8 hours to 12 hours, from 12 hours to 16 hours, from 16 hours to 20 hours, from 20 hours to 24 hours, or any combination of one or more of these ranges. Also, for example, the second heat treatment may be at a temperature of from 80° C. to 90° C., from 90° C. to 100° C., from 100° C. to 110° C., from 110° C. to 120° C., or any combination of one or more of these ranges, for a time period of from 4 hours to 8 hours, from 8 hours to 12 hours, from 12 hours to 16 hours, from 16 hours to 20 hours, from 20 hours to 24 hours, or any combination of one or more of these ranges.

In one or more embodiments, the heating of the initial zeolite precursor solution forms the crystalized zeolite-Y particles but leaves some components unreacted in a residual liquid solution. Generally, the residual liquid solution, in which the zeolite-Y particles are present following the crystallization by heating, remains, which may include some remaining non-crystalized silica source material and/or some remaining non-crystalized alumina source material, but in different ratios than present in the initial zeolite precursor solution. For example, in some embodiments, a good portion or all of the alumina from the alumina source material may be crystalized and formed into the zeolite-Y particles. However, a portion of the silica from the silica source material may remain in this residual liquid solution. As such, the residual liquid solution may, in some embodiments, have a lower alumina to silica molar ratio than that initial zeolite precursor solution. This ratio is restored to at least near that of the initial zeolite precursor solution by addition of additional silica and/or alumina source materials to form the recycled zeolite precursor solution, as described herein.

As described herein, the molar ratio of alumina to silica refers to the molar ratio of alumina to silica that is present in solution, where alumina and silica amounts are inclusive to molecules that include alumina and/or silica, such as those described with respect to the silica source materials and/or alumina source materials. For example, if NaAlO₂ was present in the residual liquid solution, it would count as one molar part of alumina even though NaAlO₂ is not alumina.

According to one or more embodiments, following the formation of the zeolite-Y particles in residual liquid solution, the zeolite-Y particles are separated from the residual liquid solution. Separation may be by a wide variety of techniques, and generally phase separation techniques may be suitable since the zeolite Y particles are solids and the residual liquid solution is a liquid. For example, centrifugation may be utilized to separate the zeolite-Y particles from the residual liquid solution. Separation of the zeolite Y particles may be complete or incomplete where, for example, some small amount of zeolite Y particles remain in the residual liquid solution, but this is not desirably the case.

Following separation of the zeolite Y particles from the residual liquid solution, the zeolite Y particles may be washed and/or dried. Washing may be with water, and may be conducted until the pH of the zeolite Y particles is from about 8 to 9. Drying may be by presence in ambient conditions or by heating, such as relatively low temperature heating. Following drying, the zeolite Y particles may be calcinated by exposure to heat. The calcination may be performed by exposure to temperatures of from 300° C. to 500° C. for 4 to 10 hours.

In embodiments, a recycled zeolite precursor solution may be formed that comprises at least a portion of the residual liquid solution (after separation of the zeolite Y particles) and additional alumina source material and/or additional silica source material. The amount of additional alumina source material and/or silica source material combined with the residual liquid solution is such that the relative concentrations of alumina and/or silica in the recycled zeolite precursor solution may be similar to or identical to that of the relative concentrations of alumina and/or silica in the initial zeolite precursor solution. In this way, additional alumina source material and/or additional silica source material makes up for the depleted amounts of alumina or silica present in the residual liquid solution.

As described, in one or more embodiments, the alumina to silica molar ratio of the recycled zeolite precursor solution may be similar or identical to that of the initial zeolite precursor solution. For example, the alumina to silica molar ratio of the recycled zeolite precursor solution may be within 10% of the silica to molar ratio of the initial zeolite precursor solution, such as within 9%, within 8%, within 7%, within 6%, within 5%, within 4% within 3%, within 2% or even within 1%.

The amount of alumina source material and/or silica source material to add to the residual liquid solution can be determined by measuring the composition of the residual liquid solution and comparing it to that of the initial zeolite precursor solution. In some embodiments, inductively coupled plasma mass spectroscopy can be utilized to determine the amount of alumina in the residual liquid solution and/or the initial precursor solution. However, other measurement techniques may be suitable, and it is contemplated that a wide variety of measurement techniques may be employed by the disclosed processes.

Forming the recycled zeolite precursor solution may comprise combining the additional alumina source material and/or additional silica source material with at least a portion of the residual liquid solution. As described, the amount of alumina source material may be suitable to have the alumina to silica molar ratio be about equivalent to that of the initial zeolite precursor solution. Other components of the initial zeolite precursor solution may also be added to the residual liquid solution to from the recycled zeolite precursor solution, such that the total composition of the recycled zeolite precursor solution is similar to that of the initial zeolite precursor solution. Additionally, and similarly to the aging to form the initial zeolite precursor solution, an aging step may be utilized in the formation of the recycled zeolite precursor solution. The aging procedure to form the recycled zeolite precursor solution may be similar or identical to that described herein with respect to the formation of the initial zeolite precursor solution. This aging, as described herein, may promote nucleation sites in the recycled zeolite precursor solution that eventually form the zeolite Y particles.

According to embodiments, once the recycled zeolite precursor solution is formed, it may be subjected to a heating process (sometimes referred to herein as the second heating process) in a similar or identical manner as described with respect to the heating process of the initial zeolite precursor solution to form the first batch of zeolite Y particles. This second heating process may form another batch of zeolite Y particles in a second residual liquid solution. The heating procedure performed on the recycled zeolite precursor solution may be identical to that described with respect to the heating process utilized on the initial zeolite precursor solution.

The zeolite Y particles formed from the heating process on the recycled zeolite precursor solution may subsequently be separated from the residual liquid solution, and then rinsed, dried, and/or calcined in the same manner as disclosed with respect to the zeolite Y particles formed from the initial zeolite precursor solution.

By the methods described herein, the residual liquid solution can continuously be recovered and utilized as a source material for making a new zeolite precursor solution by the addition of supplemental alumina source material. It should be understood that the “initial zeolite precursor material,” when described herein, may refer to a zeolite precursor material that includes recovered residual liquid solution from a previous zeolite Y batch. On the other hand, the initial zeolite precursor solution, in some embodiments, may be freshly prepared from acquired materials such as the silica and alumina source materials without use of a residual liquid solution.

Additionally, in other embodiments, it is contemplated that multiple batches of residual liquid solution may be combined and then utilized to form a recycled zeolite precursor solution. In such embodiments, an appropriate amount of alumina source material to add can be determined by measurement of the amount of alumina source material in the mixed batches of residual liquid solution.

In additional embodiments, both additional silica precursor material and alumina precursor material may be mixed into the residual liquid solution, along with, for example, additional solvent, to form a recycled zeolite precursor solution. It should be understood that any number of combination may be utilized regarding new amounts of components mixed with recycled components such that the composition of the recycled zeolite precursor solution is suitable for forming the zeolite Y particles.

As described herein, the zeolite-Y may be formed as particles. The particles may be shaped particles, such as spheres, or may be inconsistent in shape or otherwise globular in shape, and shape of the particles is not necessarily limited in embodiments described herein. As described herein, the size of a particle refers to the maximum length of a particle from one side to another, measured along the longest distance of the particle. For example, a spherically shaped particle has a size equal to its diameter, or a rectangular prism shaped particle has a maximum length equal to the hypotenuse stretching from opposite corners. Particle size may be measured by a variety of known techniques such as laser diffraction analysis or microscopy. In one or more embodiments, the zeolite-Y particles may be nano-sized meaning that they have an average particle size of less than 1 micron. In some embodiments, the zeolite-Y particles may have an average diameter of from 150 nm to 280 nm, such as from 150 nm to 100 nm, from 110 nm to 150 nm, from 150 nm to 200 nm, from 200 nm to 280 nm, or any combination of one or more of these ranges.

In one or more embodiments, the zeolite-Y particles described may include, in addition to micropores (present in the microstructure of a zeolite), mesopores, and the zeolite-Y particles may be mesoporous by having an average pore size of greater than 2 nm and less than or equal to 50 nm. Unless otherwise described herein, the “pore size” of a material refers to the average pore size, but materials may additionally include mesopores having a particular size that is not identical to the average pore size. The average pore size of a material can be measured using BET analysis, as is widely understood to those in the art. According to one or more embodiments, the zeolite Y particles may have an average pore size of greater than 2 nm, such as from 2.5 nm to 4 nm, such as from 2.5 nm to 3 nm, from 3 nm to 3.5 nm, from 3.5 nm to 4 nm, or any combination of one or more of these ranges.

In one or more embodiments, the zeolite-Y may have an average micropore volume and/or an average mesopore volume, where the total pore volume is the sum of these two. The mesopore and micropore volumes may be calculated according to the Barrett-Joiner-Halenda (BJH) method of determining mesopore volume known to one having skill in the art. Details regarding the t-plot method and the BJH method of calculating micropore volume and mesopore volume respectively are provided in Galarneau et al., “Validity of the t-plot Method to Assess Microporosity in Hierarchical Micro/Mesoporous Materials”, Langmuir 2014, 30, 13266-13274, for example. In one or more embodiments, the zeolite Y particles may have a total pore volume of rom 0.45 ml/g to 0.7 ml/g, such as from 0.45 ml/g to 0.5 Ml/g, from 0.5 ml/g to 0.55 Ml/g, from 0.55 ml/g to 0.6 Ml/g, from 0.6 ml/g to 0.65 Ml/g, from 0.65 ml/g to 0.7, or any combination of one or more of these ranges.

In one or more embodiments, the zeolite-Y particles may have an average surface area of at least 600 m²/g, such as at least 625 m²/g, at least 750 m²/g, as determined through the Brunauer-Emmett-Teller (BET) method (average BET surface area).

As described herein, crystallinity is a measurement of the degree of structural order in a solid. A more crystalline solid will have its atoms and molecules arranged in a more regular and periodic manner than a less crystalline solid. Crystallinity is typically determined by x-ray diffraction. A particular diffraction peak can be selected and its intensity normalized. Zeolites can be analyzed and the diffraction intensity normalized against the standard producing a relative crystallinity based on a standard zeolite structure. In one or more embodiments, the zeolite-Y particles may have a relative crystallinity based on the crystallinity of CBV-100, available from Zeolyst International, of greater than 100%.

The zeolite Y particles described herein may be utilized alone or in combination with other materials as catalyst used in hydrocracking processes. Such a process may have at least two functions: cracking of high molecular weight hydrocarbon and hydrogenating the unsaturated molecules. However, the relatively small pore size (e.g. average pore size less than 2 nm) of most conventional zeolites Y materials in hydrocracking catalysts generally does not favor the transport of large molecules in heavy oil fractions to diffuse into the active sites located inside the zeolite. This may cause low activity, and a possible deactivation of the catalyst. Additionally, the poor diffusion efficiency of bulky molecules can be avoided by reduced zeolite particle size due to increased external surface area and shortened diffusion path of the molecules. However, the relatively small particle size of the presently disclosed zeolite Y materials may enable for better access of reactive molecules to catalytic sites.

### EXAMPLES

The various embodiments of methods described will be further clarified by the following examples. The examples are illustrative in nature, and should not be to limit the subject matter of the present disclosure.

### Comparative Example 1 (CE-1)-Zeolite-Y Synthesis from Non-Recycled Components

First 68.0 g of sodium hydroxide (NaOH) was stirred and dissolved in 392.4 g of water in a glass bottle. To this mixture 16.4 g of sodium aluminate (NaAlO₂) and 210 g of 40 wt. % colloidal silica was added and stirred for 1 hour. The mixture was then stirred and aged at 30° C. for 20 hours. The resulting hydrogel mixture was next placed in the same bottle used for aging and crystallized at 60° C. for 12 hours, then temperature was increased to 100° C. for at least 12 hours. The obtained mixture was filtrated and washed with water until its pH reached between 8 and 9. The resulting solid product was dried at 110° C. for 24 hours and then calcinated at 500° C. for 4 hours (2° C./min).

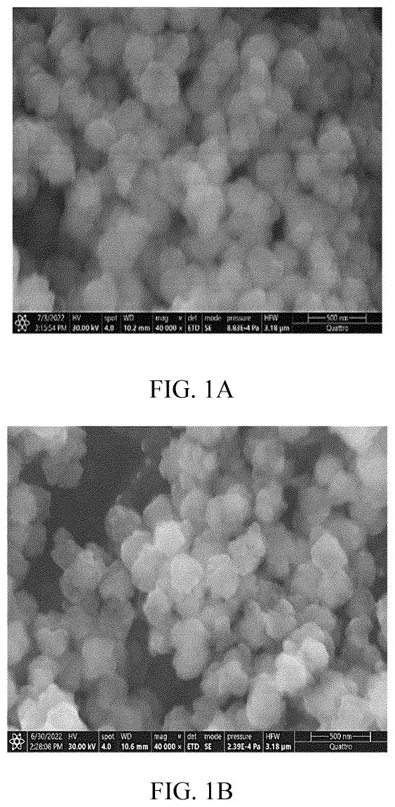

FIG. 1A depicts the average particle size of the zeolite of CE-1. For all examples the particle size measurements were carried out on a scanning electron microscope (SEM).

### Example 1 (EX-1)-Zeolite-Y Synthesis Utilizing Residual Liquid Solution

First 68.0 g of NaOH was stirred and dissolved in 392.4 g of water in a glass bottle. To this mixture 16.4 g of NaAlO₂ and 210 g of 40 wt. % colloidal silica was added and stirred for 1 hour. The mixture was then stirred and aged at 30° C. for 20 hours. The resulting hydrogel mixture was next placed in the same bottle used for aging and crystallized at 60° C. for 12 hours, then temperature was increased to 100° C. for at least 12 hours. The mixture was then centrifuged for separation and the resulting solid product was dried at 110° C. for 24 hours then calcinated at 500° C. for 4 hours (2° C./min). Then 650 mL of the remaining residual solution from the previous step was added to a glass bottle and 15.83 g of NaAlO₂ was completely dissolved after an hour of stirring. The temperature was increased to 30° C. and the mixture was stirred for 20 hours. The resulting hydrogel was placed into an oven and crystallized at 60° C. for 12 hours, then the temperature was increased to 100° C. for another 12 hours. The obtained mixture was then filtrated and washed with water until its pH reached between 8 and 9. The resulting solid product was dried at 110° C. for 24 hours then calcinated at 500° C. for 4 hours (2° C./min). The measurements of the compositions of the supernatant liquid for all examples were carried out using inductively coupled plasma (ICP) spectroscopy.

TABLE 1
Supernatant Solution Composition and Calculated Initial Gel
Composition

| | Feed Concentration | Supernatant Liquid |
|---|---|---|
| Component | (g/L) | Concentration (g/L) |
| Silicon (Si) | 75.62 | 63.69 |
| Aluminum (Al) | 10.42 | 0.7600 |
| Sodium (Na) | 84.30 | 65.12 |

FIG. 1B depicts the average particle size of the zeolite of EX-1.

### Example 2 (EX-2)-Supernatant Recycle Based Nano Y Zeolite Synthesis with Autoclaving

First NaOH was stirred and dissolved in water in a glass bottle. To this mixture NaAlO₂ and 40 wt. % colloidal silica was added and stirred for 1 to 4 hours. The mixture was then stirred and aged at temperature between 20° C. and 40° C. for between 10 to 30 hours, which formed an initial hydrogel. The resulting hydrogel mixture was next placed in an autoclave and crystallized at between 50° C. and 70° C. for between 12 to 24 hours, then temperature was increased to between 80° C. and 120° C. for between 12 and 24 hours. Supernatant liquid was then collected upon centrifugation of the mixture. Then a certain amount of an aluminum source is added to an amount of the supernatant liquid to keep molar composition the same as the initial hydrogel. Aluminum sources may include NaAlO₂, aluminum sulphate (Al₂(SO₄)₃), or aluminum nitrate (Al(NO₃)₃). Then at temperature between 40° C. and 60° C. the mixture was stirred for between 10 and 30 hours. The resulting hydrogel was placed in an autoclave and crystallized at between 50° C. and 70° C. for between 12 to 24 hours, then temperature was increased to between 80° C. and 120° C. for between 12 and 24 hours. The resulting product was centrifuged and washed with water until its pH reached between 8 and 9. The resulting solid product was dried for 24 hours then calcinated at temperature between 300° C. and 500° C. for between 4 and 10 hours (2° C./min).

TABLE 2
Main Properties of CE-1, EX-1, and EX-2 Zeolites

| Sample Name | CE-1 | EX-1 | EX-2 |
|---|---|---|---|
| Average particle sizes, nm | 200. | 200. | 150.-280. |
| Crystallinity % | 90.0 | 88.0 | >100. |
| Bulk Si/Al, mol/mol | 1.80 | 1.60 | |
| Framework Si/Al, mol/mol | 1.80 | 1.70 | |
| Total surface area, m²/g | 666 | 787 | >600. |
| Micropore surface area, m²/g | 597 | 687 | |
| Mesopore surface area, m²/g | 69.0 | 100. | |
| Total pore volume, ml/g | 0.670 | 0.480 | 0.450-0.700 |
| Micro pore volume, ml/g | 0.310 | 0.360 | |
| Mesopore volume, ml/g | 0.350 | 0.120 | |
| Pore size, nm | 4.00 | 2.50 | 2.50-4.00 |
| Solid product Yield, wt % | 43.9 | 81.7 | |

The present disclosure includes numerous aspects. One aspect is a method for making zeolite-Y particles, the method comprising: forming an initial zeolite precursor solution comprising an alumina source material and a silica source material in a solvent; subjecting the initial zeolite precursor solution to a first heating process to form zeolite-Y particles in a residual liquid solution, the residual liquid solution comprising some remaining non-crystalized silica source material, wherein the residual liquid solution has a different alumina to silica molar ratio than the initial zeolite precursor; separating the zeolite-Y particles from the residual liquid solution; forming a recycled zeolite precursor solution that comprises at least a portion of the residual liquid solution and one or both of additional alumina source material or additional silica source material, such that the recycled zeolite precursor solution has an alumina to silica molar ratio within 10% of the alumina to silica ratio of the initial zeolite precursor solution; and subjecting the recycled zeolite precursor solution to a second heating process to form additional zeolite-Y particles.

Another aspect is any above aspect or combination of aspects, wherein the recycled zeolite precursor solution has an alumina to silica molar ratio within 2% of the alumina to silica ratio of the initial zeolite precursor solution.

Another aspect is any above aspect or combination of aspects, wherein the recycled zeolite precursor is formed by at least: combining the additional alumina source material with at least a portion of the residual liquid solution to form a mixture; and aging the mixture by agitating the mixture for at least 10 hours.

Another aspect is any above aspect or combination of aspects, wherein the alumina source material comprise one or more of NaAlO₂, Al₂(SO₄)₃, Al(NO₃)₃, AlCl₃, NaAlO₂, or Al₂O₃.

Another aspect is any above aspect or combination of aspects, wherein the silica source material comprises one or more of colloidal silica, fumed silica, or tetraethyl orthosilicate, or Na2SiO3.

Another aspect is any above aspect or combination of aspects, wherein forming the initial zeolite precursor solution comprises: mixing a basic compound, a silica source material, and an alumina source material into the solvent to form a mixture; and aging the mixture by agitating the mixture for at least 10 hours.

Another aspect is any above aspect or combination of aspects, wherein the solvent is water.

Another aspect is any above aspect or combination of aspects, wherein the initial zeolite precursor solution does not include a structure directing agent.

Another aspect is any above aspect or combination of aspects, wherein the first heating process comprises heating at a temperature of from 50° C. to 70° C. for a time period of from 4 hours to 24 hours, followed by heating at a temperature of from 80° C. to 120° C. for a time period of from 4 hours to 24 hours.

Another aspect is any above aspect or combination of aspects, wherein the first heating process is under elevated pressure, elevated humidity, or both, relative to ambient conditions.

Another aspect is any above aspect or combination of aspects, wherein the first heating process is performed in an autoclave.

Another aspect is any above aspect or combination of aspects, wherein the second heating process comprises heating at a temperature of from 50° C. to 70° C. for a time period of from 4 hours to 24 hours, followed by heating at a temperature of from 80° C. to 120° C. for a time period of from 4 hours to 24 hours.

Another aspect is any above aspect or combination of aspects, wherein the second heating process is under elevated pressure, elevated humidity, or both, relative to ambient conditions.

Another aspect is any above aspect or combination of aspects, wherein the second heating process is performed in an autoclave.

Another aspect is any above aspect or combination of aspects, wherein the zeolite-Y particles have an average particle size of from 150 nm to 280 nm.

Another aspect is any above aspect or combination of aspects, wherein the zeolite-Y particles have an average pore size of from 2.5 to 4 nm.

Another aspect is any above aspect or combination of aspects, wherein the zeolite-Y particles have a total pore volume of from 0.45 ml/g to 0.7 ml/g.

Another aspect is any above aspect or combination of aspects, wherein the zeolite-Y particles have an average surface area of at least 600 m2/g.

Another aspect is any above aspect or combination of aspects, wherein the zeolite-Y particles have an relative crystallinity of greater than 100%.

Another aspect is any above aspect or combination of aspects, further comprising: washing the zeolite Y particles; drying the zeolite-Y particles; and calcinating the zeolite-Y particles.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butene may include a mixture of various isomers of butene. It should be appreciated that the examples supply compositional ranges for various streams, and that the total amount of isomers of a particular chemical composition can constitute a range.

What is claimed is:

1. A method for making zeolite-Y particles, the method comprising:
forming an initial zeolite precursor solution comprising an alumina source material and a silica source material in a solvent;
subjecting the initial zeolite precursor solution to a first heating process to form zeolite-Y particles in a residual liquid solution, the residual liquid solution comprising some remaining non-crystalized silica source material, wherein the residual liquid solution has a different alumina to silica molar ratio than the initial zeolite precursor;
separating the zeolite-Y particles from the residual liquid solution;
forming a recycled zeolite precursor solution that comprises at least a portion of the residual liquid solution and one or both of additional alumina source material or additional silica source material, such that the recycled zeolite precursor solution has an alumina to silica molar ratio within 10% of the alumina to silica ratio of the initial zeolite precursor solution; and
subjecting the recycled zeolite precursor solution to a second heating process to form additional zeolite-Y particles.

2. The method of claim 1, wherein the recycled zeolite precursor solution has an alumina to silica molar ratio within 2% of the alumina to silica ratio of the initial zeolite precursor solution.

3. The method of claim 1, wherein the recycled zeolite precursor is formed by at least:
combining the additional alumina source material with at least a portion of the residual liquid solution to form a mixture; and
aging the mixture by agitating the mixture for at least 10 hours.

4. The method of claim 1, wherein the alumina source material comprise one or more of NaAlO₂, Al₂(SO₄)₃, Al(NO₃)₃, AlCl₃, NaAlO₂, or Al₂O₃.

5. The method of claim 1, wherein the silica source material comprises one or more of colloidal silica, fumed silica, or tetraethyl orthosilicate, or Na₂SiO₃.

6. The method of claim 1, wherein forming the initial zeolite precursor solution comprises:
mixing a basic compound, a silica source material, and an alumina source material into the solvent to form a mixture; and
aging the mixture by agitating the mixture for at least 10 hours.

7. The method of claim 6, wherein the solvent is water.

8. The method of claim 1, wherein the initial zeolite precursor solution does not include a structure directing agent.

9. The method of claim 1, wherein the first heating process comprises heating at a temperature of from 50° C. to 70° C. for a time period of from 4 hours to 24 hours, followed by heating at a temperature of from 80° C. to 120° C. for a time period of from 4 hours to 24 hours.

10. The method of claim 1, wherein the first heating process is under elevated pressure, elevated humidity, or both, relative to ambient conditions.

11. The method of claim 1, wherein the first heating process is performed in an autoclave.

12. The method of claim 1, wherein the second heating process comprises heating at a temperature of from 50° C. to 70° C. for a time period of from 4 hours to 24 hours, followed by heating at a temperature of from 80° C. to 120° C. for a time period of from 4 hours to 24 hours.

13. The method of claim 1, wherein the second heating process is under elevated pressure, elevated humidity, or both, relative to ambient conditions.

14. The method of claim 1, wherein the second heating process is performed in an autoclave.

15. The method of claim 1, wherein the zeolite-Y particles have an average particle size of from 150 nm to 280 nm.

16. The method of claim 1, wherein the zeolite-Y particles have an average pore size of from 2.5 to 4 nm.

17. The method of claim 1, wherein the zeolite-Y particles have a total pore volume of from 0.45 ml/g to 0.7 ml/g.

18. The method of claim 1, wherein the zeolite-Y particles have an average surface area of at least 600 m²/g.

19. The method of claim 1, wherein the zeolite-Y particles have an relative crystallinity of greater than 100%.

20. The method of claim 1, further comprising:
washing the zeolite Y particles;
drying the zeolite-Y particles; and
calcinating the zeolite-Y particles.
